(19) United States
(12) Patent Application Publication
(10) Pub. No.: US 2013/0179193 A1
(43) Pub. Date: Jul. 11, 2013

(54) METHODS AND APPARATUSES FOR FACILITATION OF PATIENT COMMUNICATION

(71) Applicants: David John Perez, Santa Fe, NM (US); Timothy William Perez, Albuquerque, NM (US); Anders Engen, Conway, NH (US)

(72) Inventors: David John Perez, Santa Fe, NM (US); Timothy William Perez, Albuquerque, NM (US); Anders Engen, Conway, NH (US)

(21) Appl. No.: 13/736,068

(22) Filed: Jan. 8, 2013

Related U.S. Application Data
(60) Provisional application No. 61/584,801, filed on Jan. 9, 2012.

(51) Int. Cl. G06Q 50/24; G06Q 10/10

(52) U.S. Cl. CPC G06Q 50/24; G06Q 10/10
USPC 705/3

(57) ABSTRACT

Embodiments of the present invention provide methods of and apparatuses for coordinating patient communication in a professional office. An example method comprises providing the patient with a mobile computing device programmed to accommodate entering demographic information, consent forms and medical history. The mobile device can be programmed to allow users to sign appropriate forms, such as those required for HIPAA purposes. The device can be checked out to the patient and, if desired, appropriate physical security measures can be employed. A patient can complete the forms using the input modes allowed by the device, such as touch input or by stylus. Program-based input controls can help the user enter appropriate information. In some example embodiments, the mobile device communicates with office data systems. Declined records can be returned to the user, for example, with areas to be addressed highlighted. The present invention can also be practiced using the patient's own mobile computing device, allowing a patient to download an appropriate version of the application to it or interact with a hosted application using a mobile device's web browser or similar facility.

### CROSS REFERENCE TO RELATED APPLICATIONS

This application claims priority to U.S. provisional 61/584,801, filed Jan. 9, 2012, which is incorporated herein by reference.

### BACKGROUND

This invention relates to the field of human-computer interfaces, specifically those that facilitate communication of patient information between a patient and office data systems such as during the intake process.

Medical offices waste time and energy requiring patients to enter demographic information, sign consent forms and fill out medical history paperwork. This information must be either stored in a paper file system or manually entered into a practice management information system (PMIS). This approach takes significant time and requires office space for records storage. It also can be prone to errors in transcription and misfiled paperwork. Additionally, patients get frustrated by repeatedly providing the same information to the office. Some offices use electronic medical records (EMR) to reduce wasted space and improve record accessibility. However, this approach requires paper forms to be scanned and attached to the appropriate record. Additionally, patients still have to fill out multiple forms upon arrival at the office.

Accordingly, there is a need for methods to improve the communication of patient information between the patient and the data systems of the medical office. Current methods require extensive manual manipulation of the information that leads to errors in filing and transcription. No methods exist to take information directly from the patient to the data systems without transcribing or manually filing the information. Further, there is a need for more efficient communication to the patient of medical information that is specifically useful to the patient, such as healthy lifestyle communications and pharmaceutical availability.

### SUMMARY OF THE INVENTION

Embodiments of the present invention provide methods of and apparatuses for coordinating patient communication in a professional office. An example method according to the present invention comprises providing the patient with a mobile computing device programmed to accommodate entering demographic information, consent forms and medical history. The mobile device can be programmed to allow users to sign appropriate consent and release of information forms, such as those required for HIPAA purposes. The device can be checked out to the patient and, if desired, appropriate physical security measures can be employed to prevent theft. A patient can complete the appropriate forms using the input modes allowed by the device, such as touch input or through the use of a stylus. Program-based input controls can help ensure the user enters appropriate information. In some example embodiments, the mobile device communicates with office data systems such that the office's input staff can review the information with the option to accept or decline it. Declined records can be returned to the user, for example, with areas to be addressed highlighted. The present invention can also be practiced using the patient's own mobile computing device, allowing a patient to download an appropriate version of the application to it or interact with a hosted application using a mobile device's web browser or similar facility. Such embodiments can allow the user to login to a central web-portal to enter the data. Office staff can download the information from the web-portal upon receipt of the appropriate authorization.

Embodiments of the present invention can also allow the patient to make co-pays electronically. Additionally, the system can be used to verify insurance benefits, obtain pre-authorization for charges, and submit claims.

Embodiments of the present invention also provide for the storage of accepted data. Upon acceptance by the office staff, the data can then be available for various internal uses. Example output points include saving the form to a file server such as a in a PDF file format, printing the form to include in a patient's physical medical record file, and uploading to the practice management information system (PMIS) and electronic medical record (EMR) via manual procedures or a direct interface.

Embodiments of the present invention also provide for data to be warehoused for various later uses. An analytics engine can process the data and eliminate patient identifying information so data could be sent to appropriate data customers, such as public health entities, funding sources and insurance companies. Further, the analytics engine can create triggers for health information and targeted advertising to be sent directly to the patient, for example on the mobile device while the patient is waiting, or later to via other contact routes. The analytics engine can also provide information useful to other providers, such as by alerting drug stores when a particular illness or symptom occurs in unusually large number of patients.

### DESCRIPTION OF THE FIGURES

The accompanying drawing, which is incorporated into and forms part of the specification, illustrate embodiments of the invention and, together with the description, serve to explain the principles of the invention.

FIG. 1 is an overview illustrating an example embodiment of the invention.

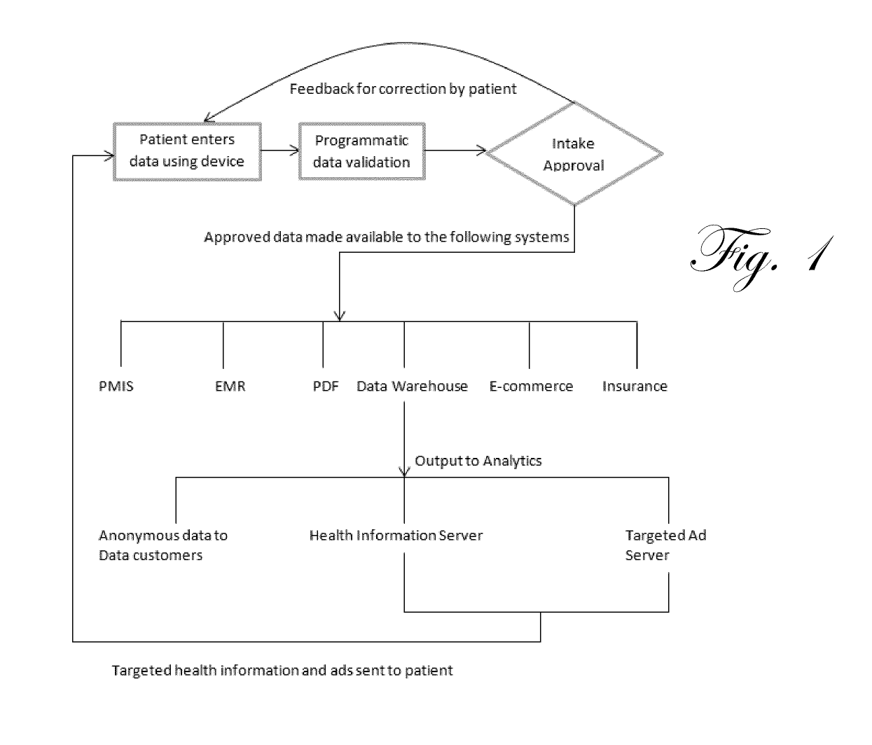

FIG. 2 is a schematic illustration of patient communication according to the present invention.

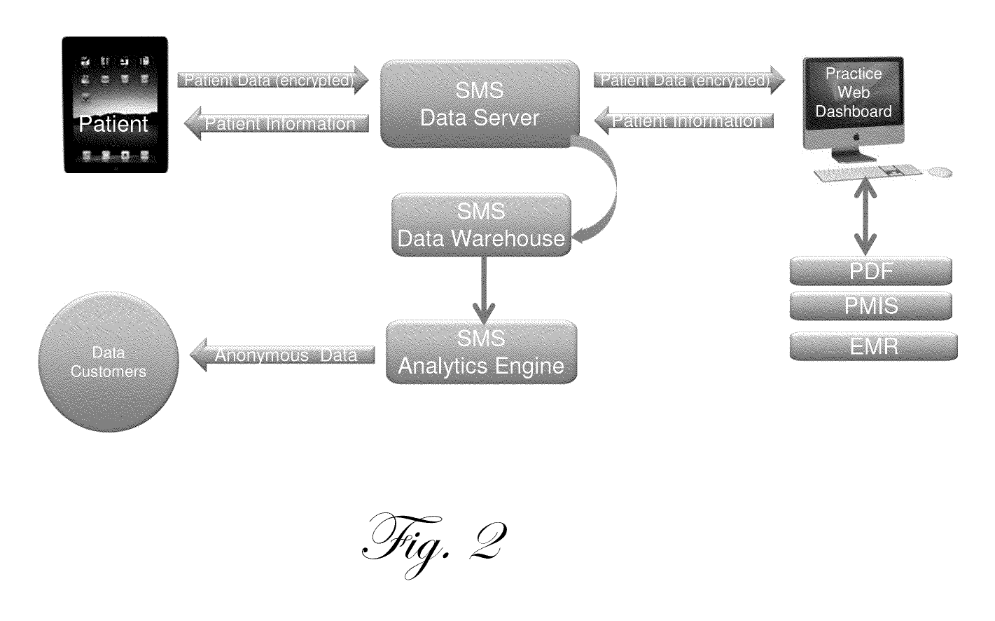

FIG. 3 is a schematic illustration of patient communication according to the present invention.

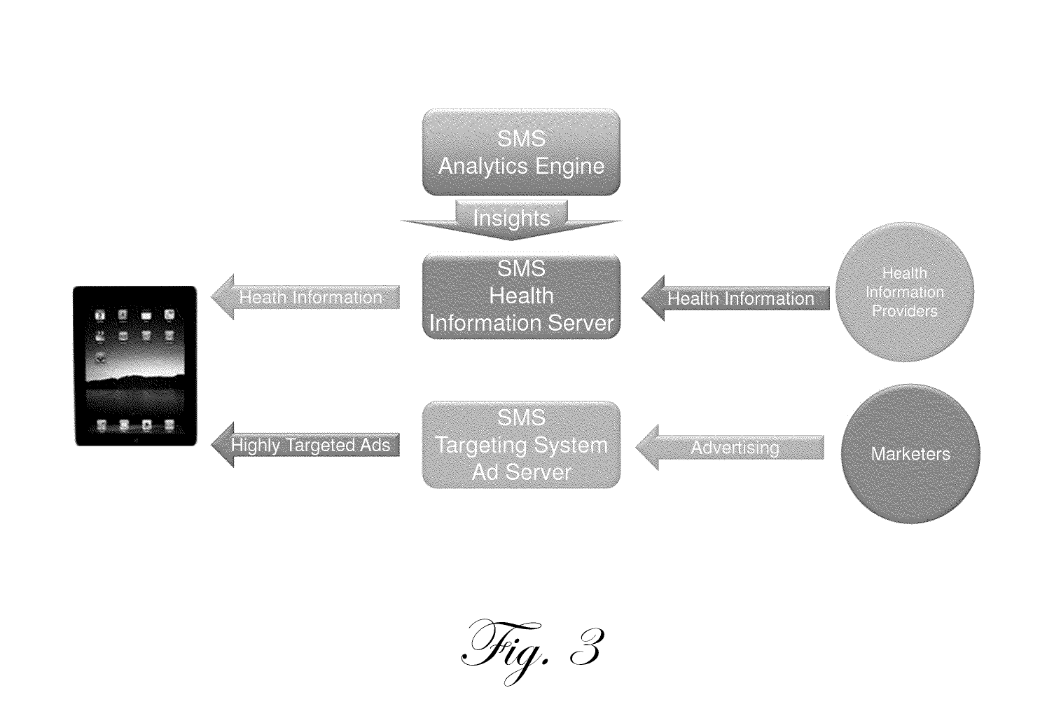

FIG. 4 is a schematic illustration of patient communication according to the present invention.

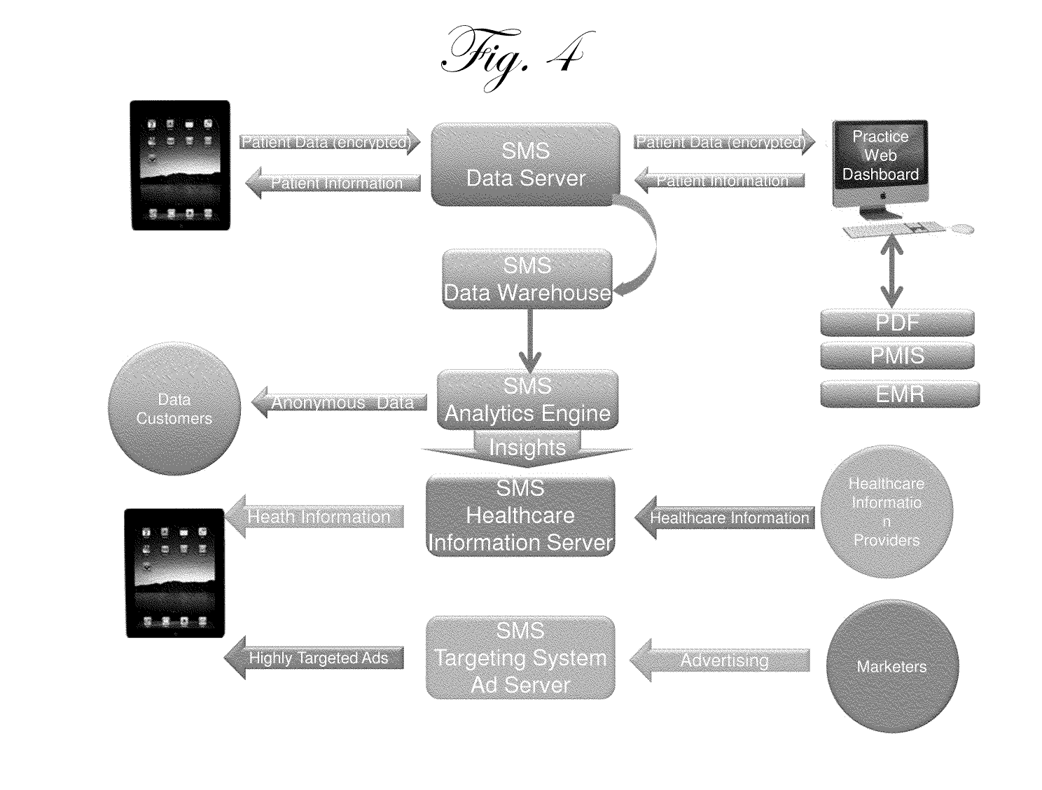

### DETAILED DESCRIPTION OF THE INVENTION

Embodiments of the present invention provide methods that facilitate the entry of patient data at medical offices and enable that data to be used in a variety of ways. Example embodiments of the present invention include methods for: securing the device, data entry and validation, making necessary payments, establishing insurance eligibility, submitting insurance claims, storing patient data, and allowing the data to be utilized for a variety of purposes. In some such examples, the security component comprises: a method for checking the device out to the patient, a method for setting a proximity alarm, and a method for combining these approaches with software such as Computrace LoJack security software. The registration component can comprise obtaining an ID for the patient, a signature acknowledging receipt of the device and a photo of the patient obtained by the device. In some embodiments, the proximity alarm can activate an audible alarm and can otherwise deactivate the device when it is moved outside a defined range.

In some example embodiments, the patient can enter data, such as demographic data, signatures for consent forms and medical history information, using a mobile computing device. In such embodiments, the mobile computing device can be a device such as a smartphone, iPad or Android/Windows based tablet device, or a web-portal. The smartphone, iPad, tablet or other applicable device can be owned by the patient, provided by the office, or provided by a third party. For devices owned by the patient, the invention can accommodate the patient downloading an application to their device that enables them to interface with the data entry system. Devices provided by the office can be pre-loaded with the appropriate application. For a web-portal embodiment, the patient can enter data into a web-based system at a convenient time prior to the appointment, or on a mobile device at the office using the mobile device's browser or similar function. The office staff can download the information and ask the patient to verify it. Such embodiments can include: a method allowing the office staff to review the information, a method for highlighting fields needing attention and a method for allowing the patient to correct the information and re-submit it. A method for review can allow the staff to accept or decline the information.

Some example embodiments provide a method by which the office staff can: print the information, save the information in a PDF file or manually upload the information into existing PMIS and/or EMR systems. Other example embodiments provide a method that enables the system to provide a direct interface into the PMIS and EMR systems utilizing industry standard protocols such as HL-7. Some example embodiments may provide methods for all four of the above approaches (print, PDF, manual upload and direct interface) to storing the data.

Some example embodiments comprise methods for a system to aggregate the data into a data warehouse. Such embodiments can include methods to utilize an analytics engine to mine the data warehouse for output to a variety of sources. Some example embodiments of the analytics engine can provide methods that can provide information to internal users for enterprise level quality control, market research, medical research and business intelligence purposes designed to improve patient outcomes. Some example embodiments of the analytics engine can have methods that can provide data to external data customers such as public health entities, universities, health care marketers and insurance companies. Some example embodiments of the analytics engine can have methods that provide data to initiate targeted advertising and health information to be sent to the patient. Such embodiments can implement the method through the use of a health information server and a targeted ad server. The health information can be provided by outside health entities. The advertising content can be provided by advertisers who participate in the system. The information can be aggregated, and patient-identifying information removed, in some embodiments.

### Example Embodiments

The present invention is described in the context of various example embodiments and applications.

An example embodiment of the present invention comprises using a device such as an iPad, smartphone or Android/Windows based tablet device to allow the patient to input demographic data, sign appropriate consent forms and provide medical history and other relevant information. The patient can check out a secured device upon arrival at the office. The device can present the patient with the necessary forms to complete and capture the patient's signature on appropriate forms. Additionally, the patient can use the device to make co-pays electronically. Further, the system can be used to verify insurance benefits.

The office staff can further ensure that the patient has entered all the appropriate information. The staff can be presented with an option to accept or decline the data, or to be prompted to communicate with the patient directly or electronically if appropriate to assist in securing the desired information. If the data is declined, the staff can highlight specific areas that need information or correction. The patient can address the areas in need of attention and re-submit them to the office staff until the data is accepted.

Upon acceptance, the data can be available in a variety of ways. The system can create a PDF file that can be saved to a file server. The PDF file can be printed and stored in a paper based records system. The data can be manually uploaded into the PMIS and/or EMR systems. The system can also directly interface with the system using an industry standard protocol such as HL-7.

The data can also be presented to a data warehouse to be aggregated and stored for a variety of uses. An analytics engine can mine data from the warehouse and make it available for various sources. The analytics engine can provide data to external data users such as public health entities or insurance companies. Further, the analytics engine can provide data to enable health information and targeted advertising information to be sent to the patient's device.

An example embodiment of a physical security sub-system of some embodiments of the invention comprises a multi-level approach to security. The first level involves the patient checking out the device from the office. The patient provides the office with identifying information such as a driver's license to verify their address and phone number. The patient uses the device to sign an acknowledgement granting release and to take their photo. A second security level involves the use of an audible proximity alarm that sounds when the device is out of range. Further, the device can be deactivated when moved outside of the range of the proximity alarm. A Global Positioning System (GPS) capability on the device can remain enabled to assist with locating the device. A third level of security involves implementing software such as Computrace LoJack on the devices. Each of these security options can be combined as appropriate to fit the needs of the client.

An example embodiment of a patient interface sub-system of the present invention comprises using an iPad, smartphone or Android/Windows based tablet device to allow the patient to enter the data. The patient can be presented with a series of questions and can use their finger or a stylus to select the appropriate answer, or a keyboard or on-screen keyboard to enter required information. Validation controls can ensure that things like phone numbers and addresses are in the proper format. For appropriate questions, these controls can limit the answers to possible acceptable choices. The office staff can have a dashboard view that allows them to see the data entered by each patient. The office staff can interact with the patient as the patient enters data, or can review the completed form after appropriate milestones in the data entry task are complete (e.g., once particular forms are completed). Once the patient submits a form, the office staff can have an option to accept or decline the form. If they decline the form, they can highlight the fields that need patient correction and send the form back to the patient. This process can continue until the data is accepted by the office staff. This bi-directional communication can be suited for a wireless network configuration or with other network configurations.

An example embodiment can allow for a direct connect upload of data from the device in the event that network concerns prohibit bi-directional communication between the office staff and patient. In this mode the data can be submitted to the system via a direct connection to the data server, for example by connecting a device to a server by USB cable. In such an implementation, the staff can load the data via a connection like a USB connection, verify the data and highlight information needed. Then they can return the device to the user for correction, or make the corrections manually.

Another example of a patient interface sub-system of the present invention allows the user to complete the information before an office visit using a central web-portal. The office staff can download the information from the web-portal. When the patient arrives, they are given a mobile computing device to verify the information entered and make any corrections highlighted by the staff.

Another example embodiment of a patient interface sub-system involves an application that allows the patient to use their own mobile computing devices, such as a smartphone, iPad or tablet. The patient can download the application to the device. The application can include appropriate controls to allow the device to communicate with the local system securely.

An example embodiment of a data integration sub-system involves the form being saved as a PDF document. This document can be placed on a file server in an appropriate location for patient data. In an office that maintains a paper based medical record, the document can be printed and placed in the patient's medical records file.

Another example embodiment of a data integration sub-system involves the intake staff manually loading the information into the PMIS and/or EMR. This can require the office staff to re-enter the information into the PMIS and/or EMR systems. It can also occur by utilizing copy and paste commands, or by using a custom macro or utility process to upload the data into the PMIS and/or EMR systems, or a combination of the preceding.

Another example embodiment of a data integration sub-system involves the use of industry standard data communication protocols, such as HL-7, to directly interface with the PMIS and/or EMR systems. Data acceptance by the office staff can cause the information to be loaded directly into the appropriate systems.

Another example embodiment of a data integration sub-system provides an ability to use any of the various approaches to load the data. This allows for flexibility to work with a variety of systems and office procedures.

An example embodiment of a data warehouse sub-system involves a custom database engine that stores aggregated data. Patient identifying information can be stripped away and data can be consolidated into common categories or groups for analysis. The data can be stored in a way that allows the analytics engine to easily parse out the data it needs. Additionally, the data warehouse can be available to internal data users for enterprise level quality control, market research, medical research and business intelligence designed to improve patient outcomes.

An example embodiment of an analytics engine sub-system involves taking the information and making it available to various data users in a useful manner. One example use for the analytics engine is to deliver the data to a health information server to trigger health information to be delivered to the patient. Another example use is for the analytics engine to deliver information to an advertising server to deliver targeted information to the patient in the waiting room. Another example use is to deliver pertinent information to a relevant public health authority. Further, internal data users can use the information that the analytics information gleans from the data warehouse to improve patient outcomes.

An example embodiment of the present invention comprises a sub-system that uses information output from an analytics engine to trigger health information and targeted advertising to be sent to the patient's device while they are waiting to see the doctor. A system such as this can use the demographic and clinical information, in addition to other relevant data, to trigger health information to be sent to the patient. In this example, health information providers can provide the information and define the target market. A server can determine the information to be displayed and deliver it to the appropriate device. Similarly for targeted advertising, advertisers can define the target markets and provide the advertising content. A server can determine the information to be displayed and deliver it to the appropriate device. These systems can use separate servers or can be hosted on the same physical server.

Implementation of the present invention can be accommodated in a variety of ways depending on the complexity of the system. For example, the data warehouse, analytics engine, health information server, targeted ad server and data/application server can all be hosted on separate physical machines. Alternatively, each of these processes can run on the same physical server through the use of either separate processes or virtual servers.

Implementation can include a variety of ways for the patient to input the initial data. The patient can use a device provided by the office. The patient can use their own device such as a smart phone or tablet device. The patient can also enter the data using a web-portal prior to appearing at the office.

Implementation can include a variety of ways to store the data once it is accepted by the office staff. The patient data can be stored as a PDF file on a file server. It can be printed out and included in a paper medical record system. The data can be manually uploaded into the PMIS and/or EMR systems either through manually rekeying the information by staff or through a semi-automated macro or utility program. Further, the data can directly interface with the PMIS and/or EMR using an industry standard data communication protocol such as HL-7.

### Example Embodiment

The example embodiment can provide an iPad based application for use by patients in medical practices. It can be used to capture patient demographics, HIPAA consent forms, and medical history data for use by the medical practice replacing paper forms and clipboards. The platform can provide patients with educational healthcare content that will be sponsored with advertising by healthcare and pharmaceutical marketers. A data warehouse can compile masked patient data and be available for demographic and clinical analytics to medical practice and other clients.

The example embodiment can extend the electronic operating environment of the medical practice into the hands of the patient in the waiting room at the very front end of the patient workflow. This can be achieved using the iPad, a device that is current, widely accepted, and user friendly.

The patient can enter data in three sections: registration and demographics, HIPAA and other consent forms such as privacy policy and disclosure forms and Review of Systems (ROS). These sections in the example embodiment can take the place of the paper forms commonly used in medical practices. The output can be pdf files that the practice can either print or incorporate into existing systems. The system can also provide interfacing via HL7 messaging to the practice's PMIS for registration, demographics, and HIPAA consent data. The system can also provide interfacing via HL7 messaging to the practice's EMR for ROS data. The system can also provide bi-directional messaging and inter-operability, primarily for demographic and insurance information, for established patients of the practice.

The system can provide packages of patient forms based on medical specialty such as: Primary Care, Urgent Care, Cardiology, Radiology, Endocrinology, Obstetrics and Gynecology, Gastroenterology, Ear, Nose and Throat, Orthopedics, Rheumatology, Oncology, Ophthalmology, Psychiatry, and others. Health education content can be pushed to the device. The practice can select other websites available to patients during the initial implementation process.

An example workflow according to the present invention can comprise:

Patient enters practice and checks in for an appointment

Admin launches app, logs on, selects specific forms for appointment, take photo of patient using camera on iPad and hands patient the iPad.

iPad prompts patient to enter his/her name

New Patients fill out demographic information and other forms as necessary

A returning patient receives demographics and is prompted to review and update them

Patient clicks “send” after update

Patient receives notification on iPad that demographic changes are required

Patient reviews demographics and corrects highlighted fields

Patient fills out other forms and provides signature using a finger tip on the iPad

Patient clicks “send”

Practice staff selects output to PDF, integration with PMIS and/or EMR

Demographics file sent to PMIS

PMIS sends insurance information to carrier where applicable

If eligibility approved, patient receives approval message

If eligibility denied, patient receives denial and updates insurance information

Patient clicks “send.” Loop

If eligibility denied, patient converted to “Self Pay” status

Patient receives co-pay prompt and instructions for electronic payment

Patient pays co-pay

Patient completes ROS

Patient clicks “send”

Practice staff receives ROS file and reviews for completeness and accuracy

Practice staff rejects file if there are errors and omissions

Patient receives notification on iPad that ROS changes are required

Patient reviews ROS and corrects highlighted fields

Patient clicks “send”

Practice staff receives file and reviews

Practice staff approves ROS file

Practice staff prints pdfs and adds to patient's medical record

Practice staff creates ROS pdf

Practice staff prints pdf and adds to patient's medical record, and/or

Practice staff attaches pdf to patient's EMR

Patient uses iPad throughout visit

Patient returns iPad to practice staff at checkout

(Patient pays co-pay)

The present invention has been described as set forth herein in relation to various example embodiments and design considerations. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method of coordinating patient input in a professional office comprising:
(a) providing a mobile computing device to a patient in the office;
(b) using the mobile computing device to present questions to the patient and receive information from the patient in an interactive manner;
(c) making the information available to a practice management information system (PMIS), an electronic medical record (EMR), or a combination thereof;
(d) performing at least one of: (d1) sending de-identified data to one or more parties other than the professional office, or (d2) using the mobile computing device to present to the patient information relevant to patient responsive to information received from patient.

2. A method as in claim 1, wherein step (d) comprises sending de-identified data to parties other than the professional office.

3. A method as in claim 1, wherein step (d) comprises using the mobile computing device to present to the patient additional information relevant to patient responsive to information received from patient.

4. A method as in claim 3, wherein the additional information comprises health education information.

5. A method as in claim 4, further comprising storing information characteristic of the patient's interaction with the additional information, comprising one of more of: identification of the additional information presented, the date the additional information was presented to the patient, the amount of time the additional information was presented to the patient, and a record of the patient's interactions with the computing device while the additional information was presented.

6. A method as in claim 3, wherein the additional information comprises information concerning products.

7. A method as in claim 1, further comprising interaction with office staff via a second computing device during step (b).

8. A method as in claim 1, further comprising using a web-based interface to present questions to the patient and receive information from the patient in an interactive manner while the patient is not in the office.

9. A method as in claim 1, wherein the computing device will only accept private information from the patient when the computing device has authenticated connection to a server, and wherein the computing device communicates private information to the server and does not maintain persistent storage of private information local to the computing device.

10. A method as in claim 2, wherein step (d) comprises aggregating information from a plurality of patients prior to communicating to one of more parties other than the office.

11. A method as in claim 1, wherein the information received from the patient comprises one or more of: patient demographic data, HIPAA consent, signature, and medical history information.

12. A method as in claim 1, further comprising disabling operation of the mobile computing device if the device is removed from a defined physical area.

13. A method as in claim 1, wherein step (b) comprises using one or more of: touch screen input, stylus input, speech recognition, track ball input, keyboard input.

14. A method as in claim 1, wherein step (b) comprises receiving textual information from the patient, and further comprising suggesting complete entries responsive to input if an initial subset of characters in an entry, and accepting the suggested entry responsive to indication by the patient.

15. A method as in claim 1, wherein step (b) comprises limiting the information that can be received from the patient responsive to information concerning the patient.

16. A method as in claim 1, wherein step (c) comprises communicating information using a wireless network.

17. A method as in claim 1, further comprising review by the office staff of the information received from the patient, and communication to the patient if said review indicates correction or additional information is required.

18. A method as in claim 1, further comprising printing or storing as an image file information received from the patient, or abstracts or summaries thereof.

19. A method as in claim 1, further comprising accepting payment from the patient.

20. A method as in claim 2, further comprising analyzing the information received from a plurality of patients and communicating de-identified information, or abstracts or summaries thereof, to parties other than the office.
